(19) United States
(12) Patent Application Publication
(10) Pub. No.: US 2011/0132226 A1
(43) Pub. Date: Jun. 9, 2011

(54) METHOD AND APPARATUS FOR CUTTING RAILROAD RAILS

(75) Inventor: Fred S. Sperling, Canton, OH (US)

(73) Assignee: Sperling Railway Services, Inc., Canton, OH (US)

(21) Appl. No.: 12/631,192

(22) Filed: Dec. 4, 2009

(51) Int. Cl. E01B 29/16; B26D 1/18; B26D 7/02; B26D 7/18; B26D 1/00; E01B 31/00

(52) U.S. Cl. 105/238.1; 83/471.3; 83/452; 83/168; 83/13

(57) ABSTRACT

A rail saw comprising a mounting boom having a pivotable arm and pivotably connected to a railroad machine with at least two pivotable axes, a saw frame rotatably connected to the pivotable arm with at least 180 degrees of rotation, a cutting frame pivotably connected to the saw frame, and a saw blade rotatably connected to the cutting frame.

### BACKGROUND OF THE INVENTION

1. Technical Field

The invention relates generally to a machine for cutting railroad rails easily and efficiently. More particularly, the invention relates to an assembly which is self-powered and moves independent of a separate machine and is capable of precise alignment with the railroad rail prior to a cutting operation. Specifically, the invention relates to a rail saw assembly and a cutting assembly which is consistently aligned perpendicular to a longitudinal axis of a railroad rail and provides a precision cut of the rail.

2. Background Information

Railroad rail saws and similar cutting tools with a rotating bit for material removal generally consist of small handheld tools. For example, common rail cutters are sized and shaped similar to a traditional concrete saw that is portable. The rail saw will include an abrasive wheel and an attachment fixture. The handheld rail saw typically incorporates a small blade of only 14″ to 16″ in diameter, thus requiring a substantial amount of cutting in order to cut through the entire rail.

An alternative to the portable rail cutter is a hydraulic or pneumatic shear style rail cutter. A shear style rail cutter uses two heads which squeeze together and shear a rail between them to cut the rail. While the shear style rail cutter is much faster than the portable style rail cutter, the shear cut is not very clean and causes a great deal of deformation on both ends of the cut rail. Specifically, the cut rail ends cannot be easily reused because of the deformation at the end of the rail that is to remain in operation.

Still another type of rail cutter is an enlarged portable railroad rail cutter secured to a boom, such as the model manufactured by Kershaw Manufacturing. The boom is part of a railroad machine that permits movement away from the railroad machine. The enlarged portable rail saw is connected to the free end of the boom and extends down from that free end. The operator must again stand very close to the cutting blade and is required to position the enlarged portable cutting unit in the proper position and maintain that position during the cutting process. Further, because the operator is located near the cutting blade, the cutting blade rotation must feed the sparks caused during the cutting process back toward the machine and thus creates a dirty and problematic condition for the cutting assembly. Finally, the operator is required to constantly pull the cutting assembly during the cutting operation and thus leads to inconsistent and uneven cutting of the railroad rail.

### SUMMARY OF THE INVENTION

The present invention broadly comprises a railroad rail saw including a mounting boom for connection to a railroad machine, a saw frame secured to the mounting boom, a saw mounted to the saw frame, and wherein a saw blade is maintained perpendicular to a longitudinal axis of a rail during a cutting operation.

The present invention also broadly comprises a rail saw including a mounting boom having a pivotable arm and pivotably connected to a railroad machine with at least two pivotable axes, a saw frame rotatably connected to the pivotable arm with at least 180 degrees of rotation, a cuffing frame pivotably connected to the saw frame, and a saw blade rotatably connected to the cutting frame.

The present invention further broadly comprises a method of cutting a railroad rail including the steps of locating a railroad machine having a rail saw assembly proximate a rail, disengaging a rail saw assembly rail clamping mechanism, moving a saw frame from a transit position to a cutting position, engaging the rail clamping mechanism on at least two sides of the rail, rotating a saw, and pivoting the saw with a feed rate controller to cut the rail.

### BRIEF DESCRIPTION OF THE DRAWINGS

A preferred embodiment of the invention, illustrated of the best mode in which Applicant contemplates applying the principles, is set forth in the following description and is shown in the drawings and is particularly and distinctly pointed out and set forth in the appended claims.

FIG. 1 is a side elevational view of a preferred embodiment railroad machine with a rail saw assembly secured thereon;

FIG. 2 is a front elevational view of a preferred embodiment rail saw with portions of the rail shown in section and illustrating portions of the rail saw assembly shown in dashed lines;

FIG. 2A is an enlarged sectional view showing a preferred saw assembly securing mechanism;

FIG. 3 is a front elevational view of a preferred embodiment rail saw assembly with portions shown in dashed lines;

FIG. 4 is a rear elevational view of a preferred embodiment rail saw assembly separated from the railroad machine;

FIG. 5 is a top plan view of a preferred embodiment rail saw assembly with portions shown in dashed lines;

FIG. 6 is a right side elevational view of a preferred embodiment rail saw assembly;

FIG. 7 is a rear elevational view of a preferred embodiment rail saw assembly attached to the railroad machine boom and taken generally along line 7-7 in FIG. 5;

FIG. 8 is an enlarged view of a preferred embodiment swivel joint shown in FIG. 7;

FIG. 9 is an enlarged view of a preferred embodiment eccentric joint shown in FIG. 7;

FIG. 10 is a partial cross-sectional view of a preferred embodiment eccentric joint taken generally along line 10-10 in FIG. 9;

FIG. 11 is a side view of a preferred embodiment rail saw assembly being moved from a transit position to a cutting position on the rails;

FIG. 12 is a front elevational view with portions of the rail shown in section and portions of the cutting wheel shown in dashed lines and taken generally along line 12-12 in FIG. 11;

FIG. 13 is a rear elevational view of a preferred embodiment rail saw assembly located on the rails with portions of the rail shown in section and taken generally along line 13-13 in FIG. 11;

FIG. 14 is an enlarged view of a preferred embodiment rail clamping mechanism with portions of the rail shown in section;

FIG. 15 is a front elevational view with portions of the rail shown in section illustrating a preferred embodiment rail saw assembly cutting a railroad rail and dispensing sparks into a spark guard;

FIG. 16 is an enlarged view of a preferred embodiment eccentric joint showing the eccentric movement;

FIG. 17 is a top plan view of a preferred embodiment rail saw assembly located on a railroad rail and a spark guard prepared to collect sparks from the cutting operation;

FIG. 18 is a front plan view of a preferred embodiment rail saw assembly blade traversed through a portion of a railroad rail and the rail receiving door pushed upward;

FIG. 19 is a rear elevational view of a preferred embodiment rail saw assembly with the cutting blade pivoted upward and the rail clamping mechanism unclamped;

FIG. 20 is a rear elevational view of a preferred embodiment rail saw assembly being rotated 180 degrees to cut an opposing railroad rail section. Similar numbers refer to similar parts throughout the drawings.

### DETAILED DESCRIPTION OF THE PREFERRED EMBODIMENT

At the outset, it should be appreciated that like drawing numbers on different drawing views identify identical, or functionally similar, structural elements of the invention. While the present invention is described with respect to what is presently considered to be the preferred embodiments, it is to be understood that the invention as claimed is not limited to the disclosed aspects.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

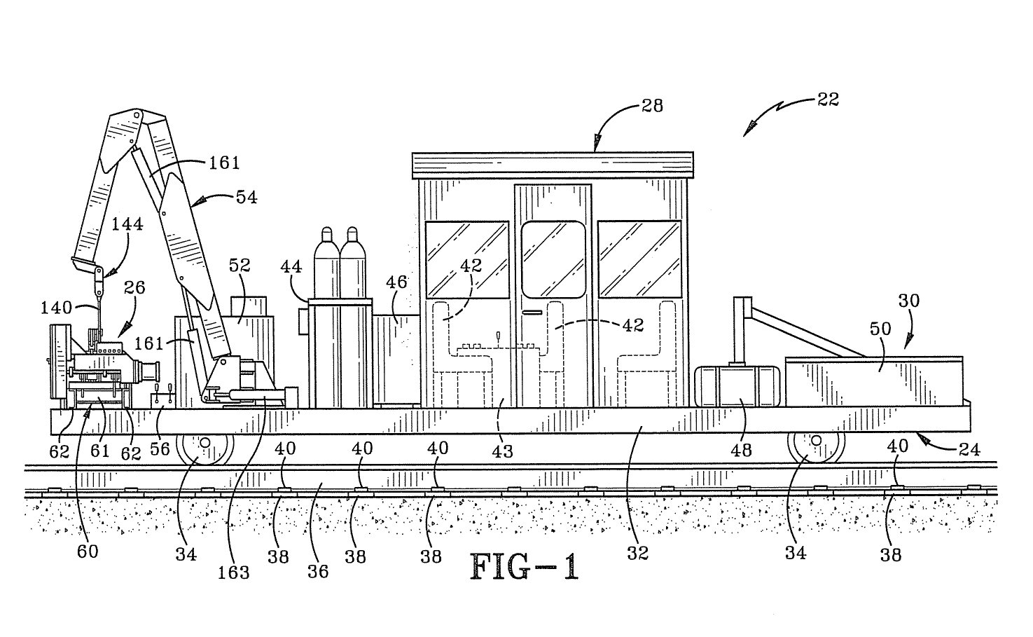

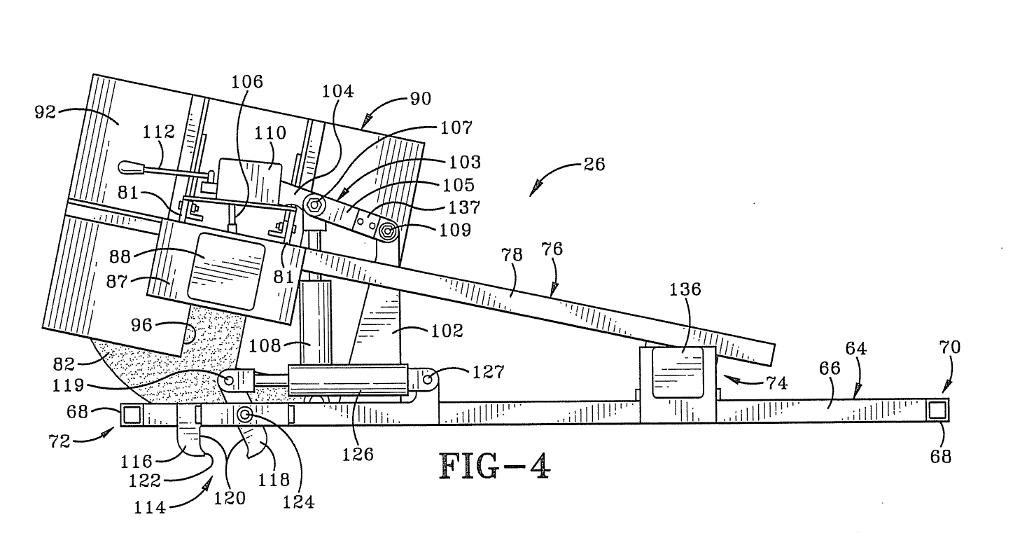

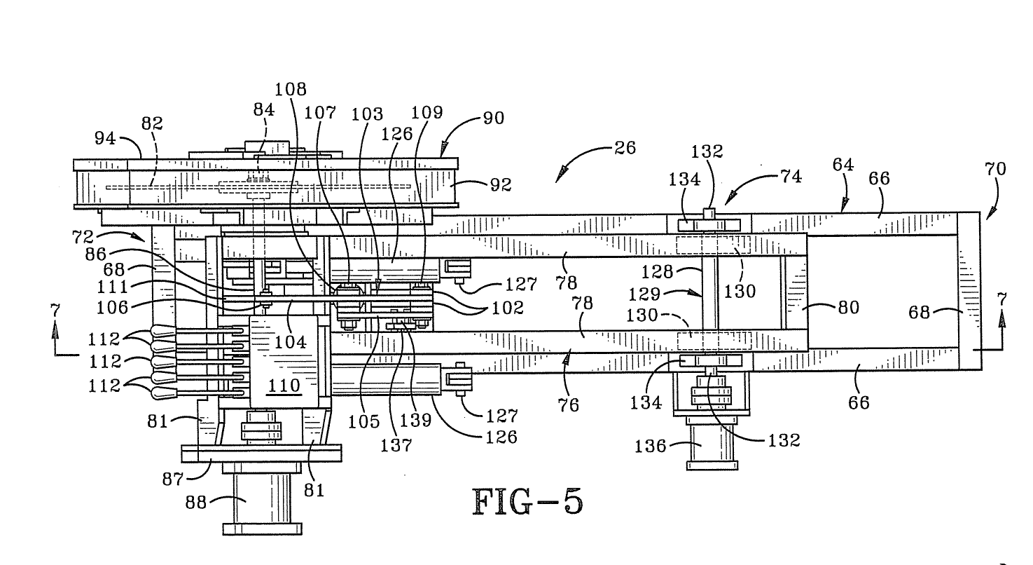

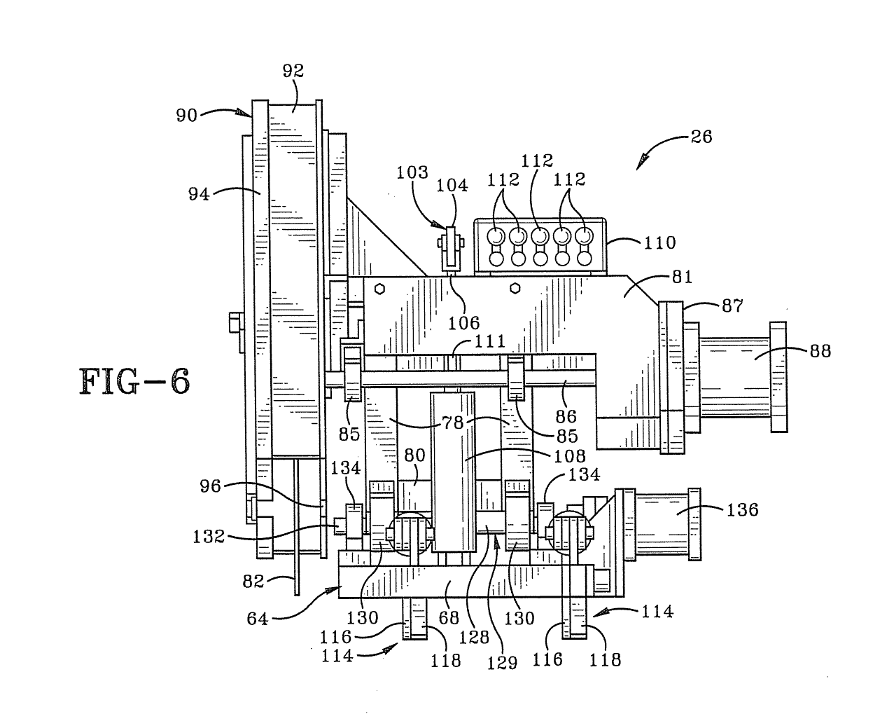

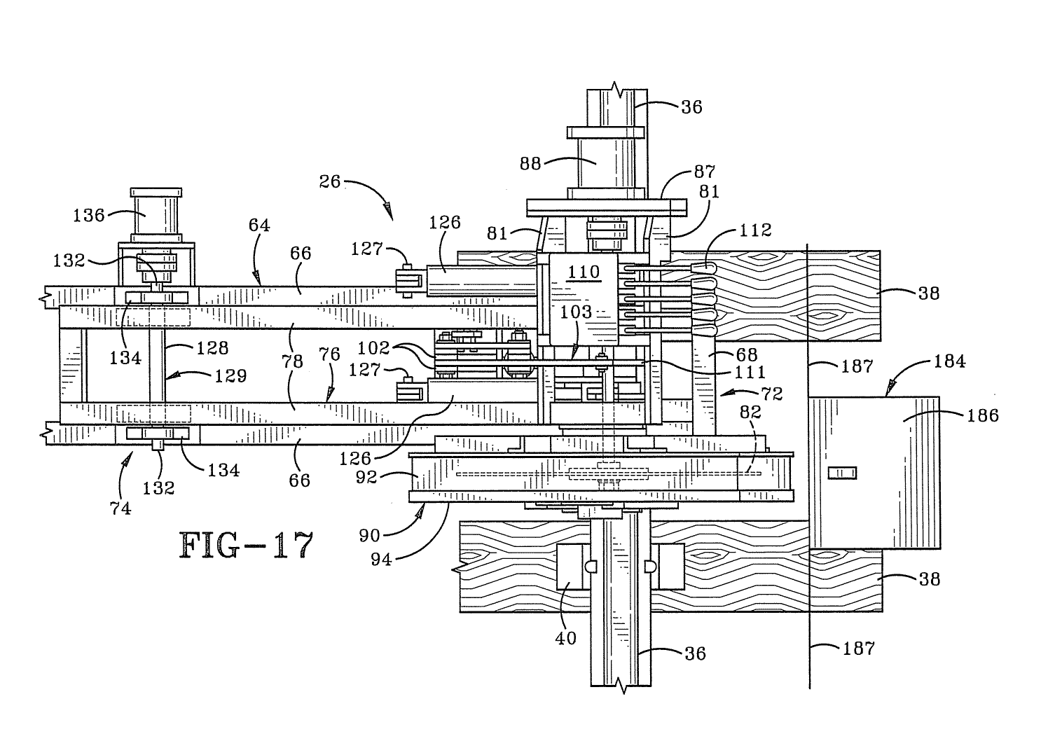

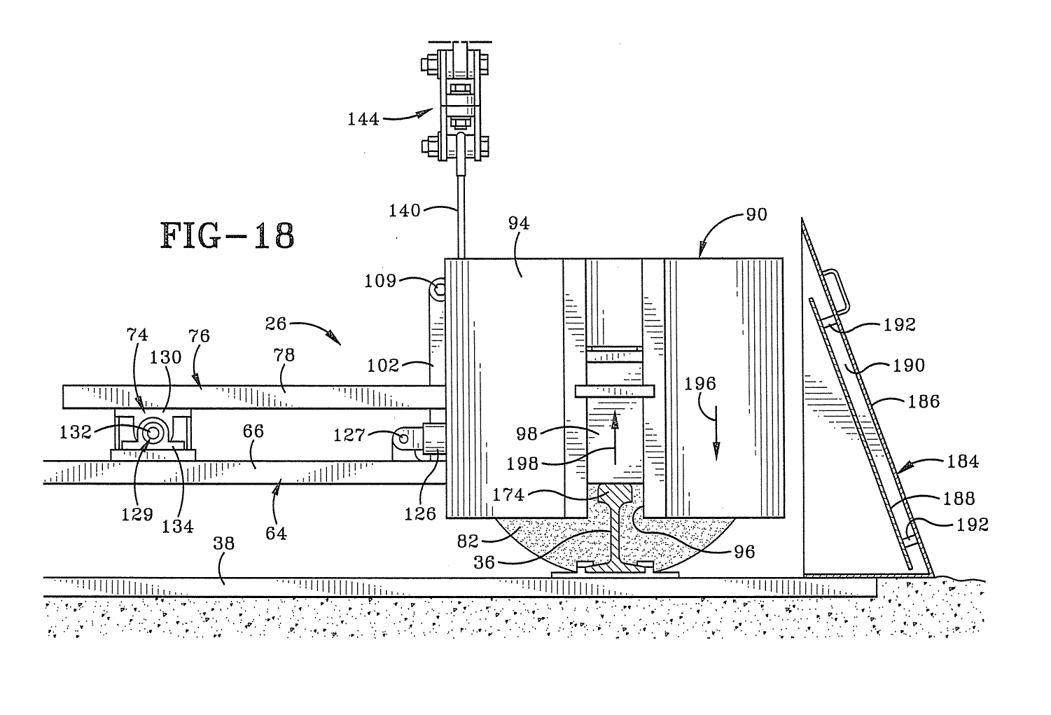

The railroad rail cutting assembly of the present invention is indicated generally at 22, and is particularly shown in FIGS. 1 through 20. As particularly shown in FIG. 1, a preferred embodiment railroad rail cutting assembly 22 includes a railroad machine 24, a rail saw assembly 26, an operator cabin 28, and a hauling platform 30. Railroad machine 24 includes a body 32 with wheels 34 arranged to ride along rails 36. Rails 36 are secured along railroad ties 38 with mounts 40 as traditionally known in the art.

Operator cabin 28 is preferably disposed centrally on body 32 and includes a pair of operator chairs 42 proximate a rail body control panel 43 to allow the railroad machine operator to move the railroad rail cutting assembly 22 in either direction with minimal disruption. Further, operator cabin 28 also includes additional space sufficient to carry personnel and thus remedies the need for an additional cart to carry personnel.

Body 32 may also include a hauling platform 30 which may be located distal rail saw assembly 26. Hauling platform 30 may also include a ramp or small boom to facilitate carrying of additional tools such as a web grinder or additional power tools which may be necessary prior to or after the rail cutting operation. Advantageously, the addition of hauling platform 30 remedies the need for an additional cart to be brought to remote locations of the track. Body 32 may also include a gas storage area 44, a hydraulic fluid tank 46, a water tank 48, and a tool storage container 50. Further, a diesel fuel tank may be located proximate hydraulic fluid tank 46, but is not seen in FIG. 1. A diesel engine 52 is preferably located proximate a boom assembly 54 and an operation panel 56. Diesel engine 52 may be used to control movement of railroad rail cutting assembly 22 along the track, as well as pump hydraulic fluid from tank 46 to operate boom 54 and rail saw assembly 26.

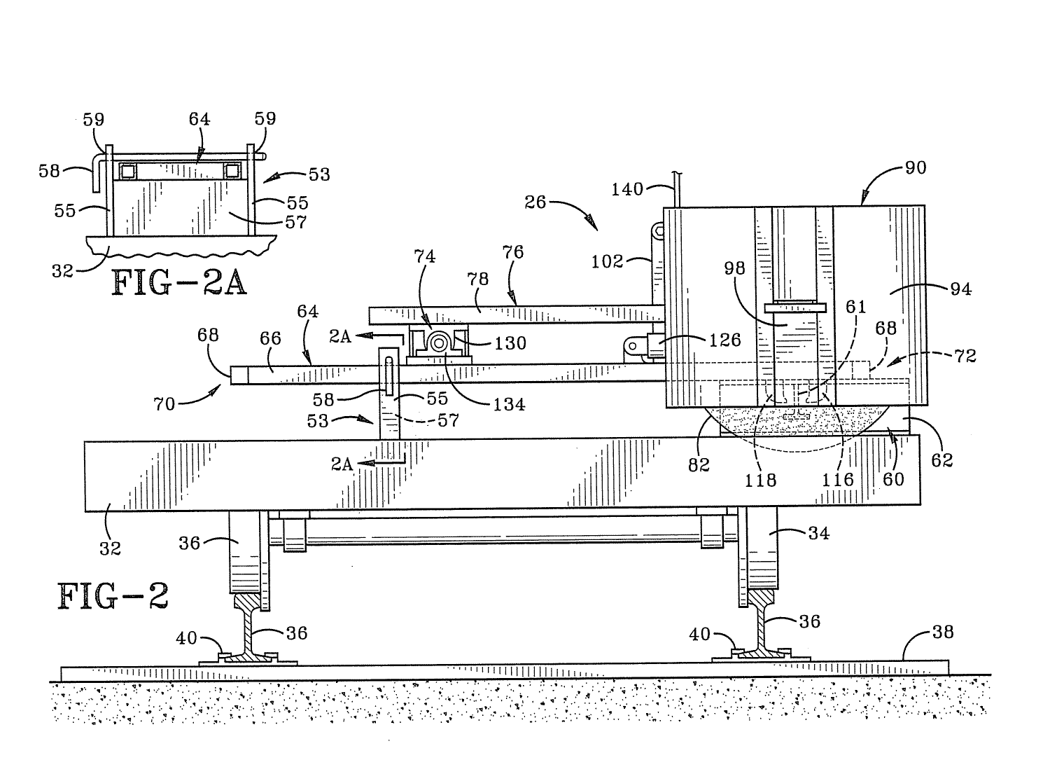

In accordance with one of the main features of the invention, FIGS. 2 and 2A illustrate railroad rail saw assembly 26 resting on body 32 and in the transit position when the railroad rail cutting assembly is being moved along rails 36. Body 32 includes a saw transport mount 53 including a clamp rail with a rail 61 extending between mounting platforms 62. Clamp rail 60 is preferably located on only a single side, but may be disposed on both sides if necessary. A base 57 is located between a pair of columns 55. Columns 55 include apertures 59 arranged to receive pin 58. Pin 58 is inserted into apertures 59 after rail saw assembly 26 is secured in the transit position and helps to prevent movement.

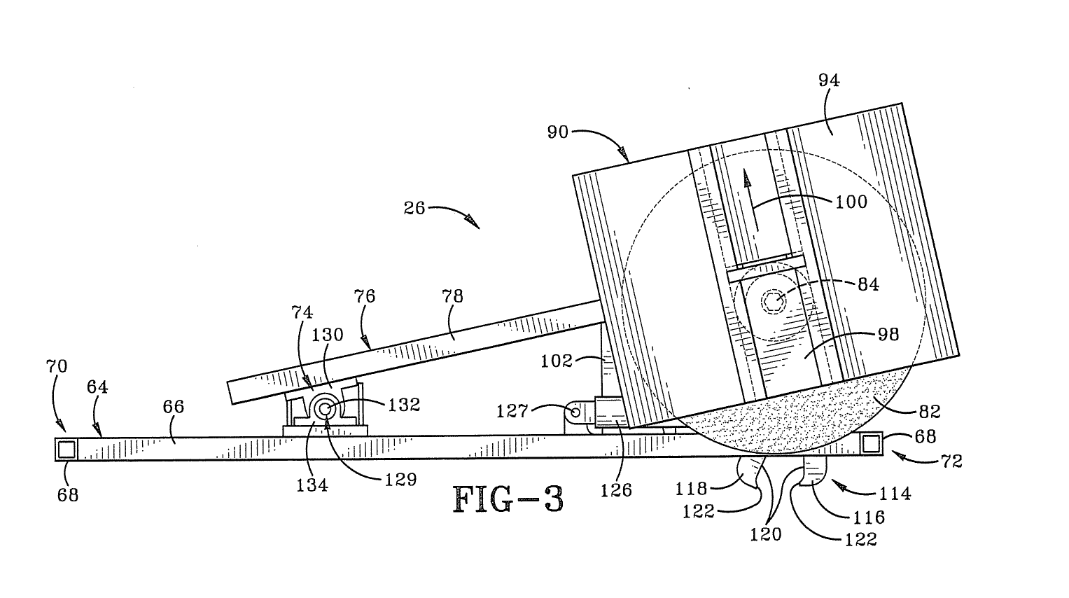

In accordance with another main feature of the invention, preferred embodiment rail saw assembly 26 is illustrated in FIGS. 3 through 6. Rail saw assembly 26 preferably includes a saw frame 64 and is preferably formed by a pair of longer side beams 66 and a pair of shorter end beams 68 arranged in a rectangular configuration. Saw frame 64 preferably defines a back end 70 of the saw rail assembly, and a lower front end 72 of the saw assembly. An eccentric pivot joint 74 is mounted to saw frame 64 and preferably located approximately ¼ to ⅓ of the length of side beam 66. Eccentric pivot joint 74 connects saw frame 64 to a cutting frame 76. Cutting frame 76 may also include longer side beams 78 and shorter end beams 80. Advantageously, this arrangement permits cutting frame 76 to pivot eccentrically about eccentric pivot joint 74 to ensure that a proper cut of a railroad rail is made.

Rail saw assembly 26 also includes a cutter, such as blade 82. Blade 82 is attached with a nut 84 and rotates with a shaft 86 during operation of a motor 88. Motor 88 is mounted on a motor mount 87, while shaft 86 is located within bearing blocks 85. Advantageously, nut 84 allows blade 82 to be easily replaced when the blade is worn down and no longer usable. Further, blade 82 is secured within shroud 90 which includes a housing 92 and a door 94. In order to access blade 82, door 94 pivots open and permits removal of nut 84. Shroud 90 also includes a rail receiving chute 96 in the back side of shroud 90 and a rail door 98 in shroud door 94. During operation, rail door 98 is forced upward in the direction associated with arrow 100 by a railroad rail as shroud 90 moves downward and cutting frame 76 pivots about eccentric joint 74.

Saw frame 64 also includes a stabilizing arm 102 and a stabilizing branch 103. Stabilizing arm 102 extends perpendicular from saw frame 64 and passes through cutting frame 76 where stabilizing branch 103 connects to the end of stabilizing arm 102 with a nut 109. Stabilizing branch 103 includes two pieces, a longer band 104 which extends to control link 106 and a shorter band 105 which attaches to a feed rate control cylinder 108 with a nut 107. Control link 106 also connects stabilizing branch 103 to cutting frame 76 through plate 111. Advantageously, control link 106 permits some movement in a direction along the longitudinal axis of side beams 78 which allows movement of the eccentric or sawing motion created at eccentric joint 74. Further, feed rate control cylinder 108 is connected to stabilizing branch 103 and controls the rate at which blade 82 and cutting frames 76 pivot at eccentric joint 74, as well as at the rate at which the blade cuts through rail 36 (not shown in FIGS. 3 through 6) and the return rate after a cutting operation.

Rail saw assembly 26 is moved into position and may be controlled with control box 110, which may be a hydraulic valve assembly, and particularly switches 112, which may be hydraulic valves. Control box 110 is connected to motor mount 87 with a bracket 81. In a preferred embodiment, because the railroad rail saw assembly is hydraulically operated, switches 112 are used to locate rail saw assembly 26 in the proper position and operate boom assembly 54. While control box 110 and switches 112 utilized in a preferred embodiment, it is within the spirit and scope of the present invention to remotely control the operation and positioning of the saw assembly with hydraulics, electronics or any other suitable means.

In accordance with another main feature of the present invention, rail saw assembly 26 preferably includes a rail clamping mechanism 114. Rail clamping mechanism 114 includes a fixed jaw 116 and a movable jaw 118. Both fixed jaw 116 and movable jaw 118 preferably have straight inner portions 120 and a curved tooth portion 122, which assists in locating tooth portion 122, which in turn assists in locating and maintaining that location during the clamping procedure. Movable jaw 118 is secured to saw frame 64 at pivot point 124 and is pivotably controlled by a locking cylinder 126 that is secured to saw frame 64 with a pin 127 and movable jaw 118 with a pin 119. Rail clamping mechanism 114 is preferably controlled by switches 112 at control box 110.

In accordance with still another main feature of the present invention, eccentric pivot joint 74 includes a shaft 129 with an inner portion 128 mounted at bearing blocks 130, an outer portion 132 located at bearing blocks 134 and a motor 136. During operation, which will be described in greater detail below, outer portion 132 is operated by motor 136 and rotates with inner portion 128 to provide an eccentric motion therein which translates into a reciprocating motion of cutting frame 76 and blade 82. Specifically, inner portion 128 is offset from outer portion 132 which creates the eccentric motion during operation and moves cutting frame 76 at bearing blocks 130. Further, in a preferred embodiment, inner portion 128 has a diameter of approximately 1 inch and outer portion 132 has a diameter of approximately 1⅜ inches.

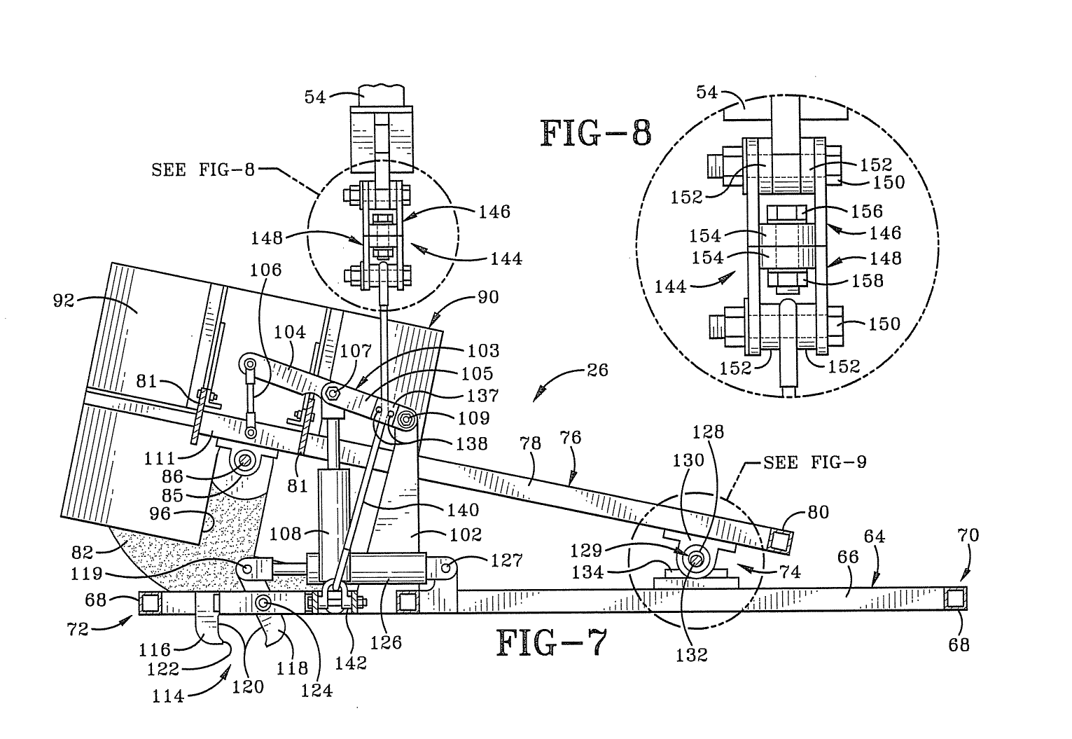

Referring now to FIGS. 7 and 8, stabilizing branch 103 includes plate 137 with a pair of locating pins 138 spaced apart to define a cavity 139 and to position rail saw cable 140 therebetween. Cable 140 terminates at shackle 142 which is centrally located to maintain the balance of rail saw assembly 26 at all times. Cable coupling joint 144 connects cable 140 to boom assembly 54. Cable coupling joint 144 is preferably comprised of an upper member 146 and a lower member 148. Both the upper and lower members include horizontally disposed bolts 150 with spacers 152 which may be formed as part of upper and lower members 146 and 148 respectively. In a preferred embodiment, spacers 152 on the bottom may be welded to lower member 148, while spacers 152 are removable from upper member 146 to allow installation of bolt 156. Further, spacers 154 may each be formed within the upper member 146 and lower member 148 and a bolt 156 is vertically located through spacers 154 and is secured together with a nut 158. Advantageously, in this arrangement, upper member 146 and lower member 148 are capable of rotating independently from one another and thus permit the saw assembly to be rotated 360 degrees without movement of boom 54.

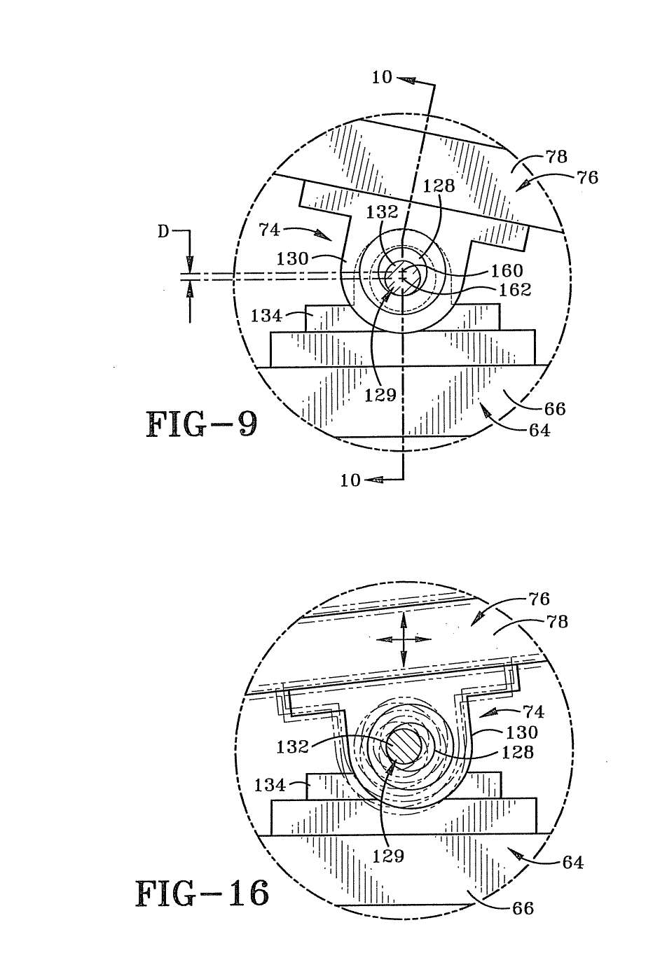

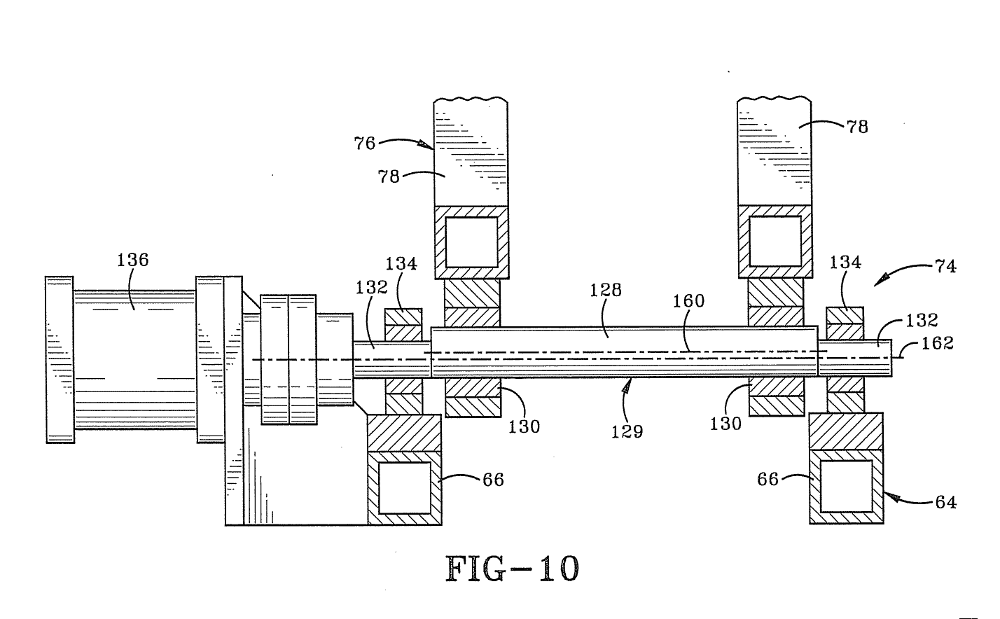

FIGS. 9 and 10 illustrate specific views of eccentric pivot joint 74. In particular, inner portion 128 includes an axis 160, while outer portion 132 includes an axis 162. Axes 160 and 162 are spaced apart a distance of approximately D offset from one another to provide the eccentric movement. Eccentric movement at joint 74 translates into reciprocating movement along cutting frame 76 with respect to saw frame 64. Advantageously, because saw frame 64 is fixed along rails 36 during operation, eccentric movement at eccentric pivot joint 74 imparts the reciprocating movement on cutting frame 76 and thus increases the cutting speed due to this reciprocating movement. Further, the distance D translates to a constant reciprocating distance equal to double the distance D. For example, if the distance D illustrated in FIG. 9 is one inch, then cutting frame 76 will have a reciprocating distance of two inches with respect to saw frame 64. Advantageously, this arrangement permits cutting frame 76 to both pivot and move reciprocally with respect to saw frame 64.

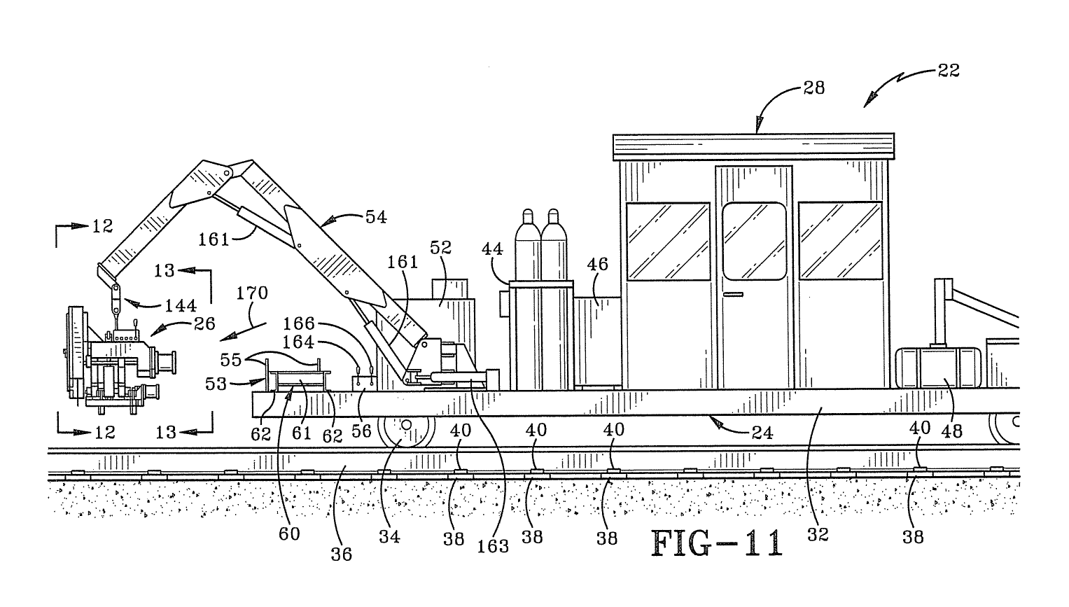

Referring to FIG. 11, rail saw assembly 26 is shown removed from saw transport mount 58 and hovering over rails 36. Rail saw assembly 26 is moved by manipulation of boom assembly 54. Boom assembly 54 is controlled with cylinders 161 controlling vertical movement, while cylinder 163 controls horizontal movement. Operation panel 56 includes a lever 164 for controlling blade 82 and eccentric motor 136. Further, a lever 166 controls feed rate cylinder 108 during operation. While operation panel 56 includes two levers, any suitable number of control levers may be utilized as well as similar control levers being included on both control panel 56 and control box 110 of rail saw assembly 26. Boom 54 may be controlled by body control panel 43 or control box 110.

Having described the structure of the preferred embodiment, a preferred method of operation will be described in detail and should be read in light of FIGS. 1 through 20 and particularly FIGS. 11 through 20.

FIGS. 11 through 14 illustrate the operation of boom assembly 54, the location of rail saw assembly 26, and the operation of rail clamping mechanism 114. First, rail clamping mechanism 114 is disengaged to permit rail saw assembly 26 to be moved from the transit position to a cutting position. The operator manipulates cylinders 161 and 163 to move rail saw assembly 26 from railroad machine body 32 as seen in FIG. 11. In particular, rail saw assembly 26 is moved in the direction associated with arrow 170 until rail saw assembly 26 is proximate rails 36.

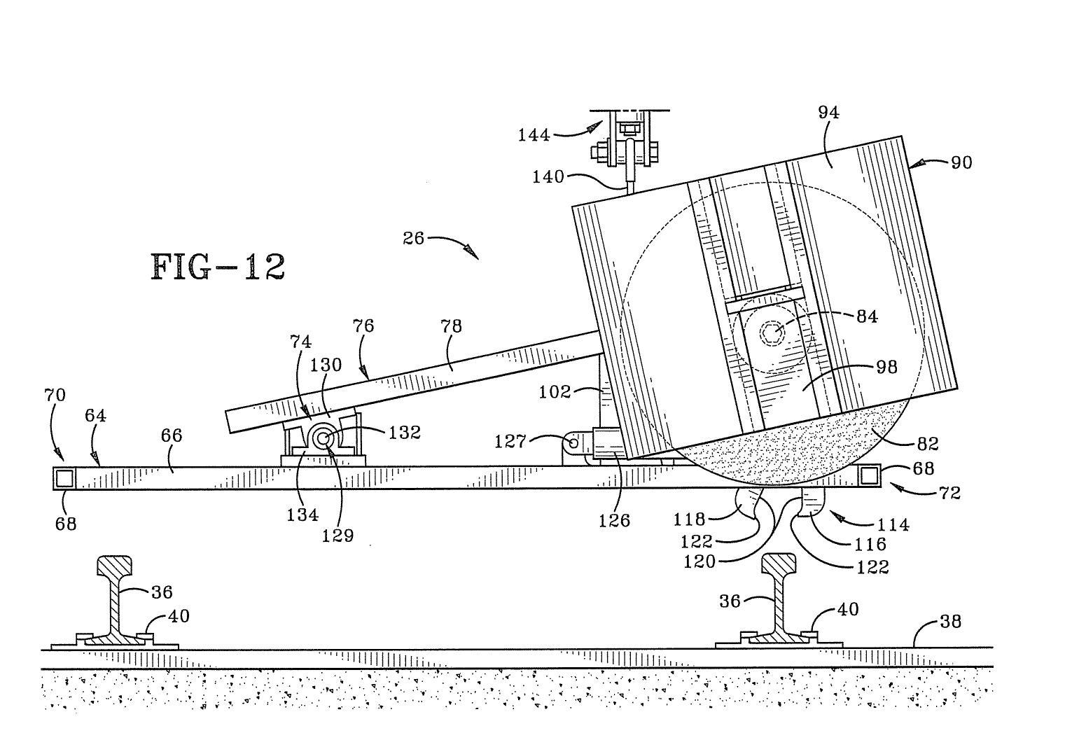

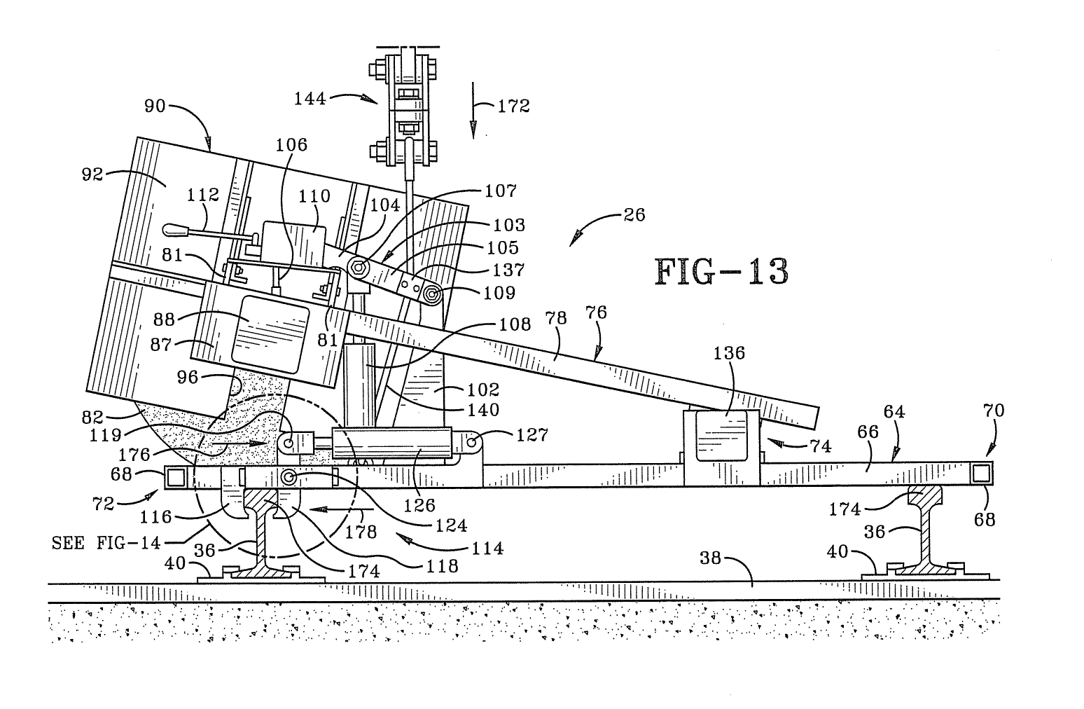

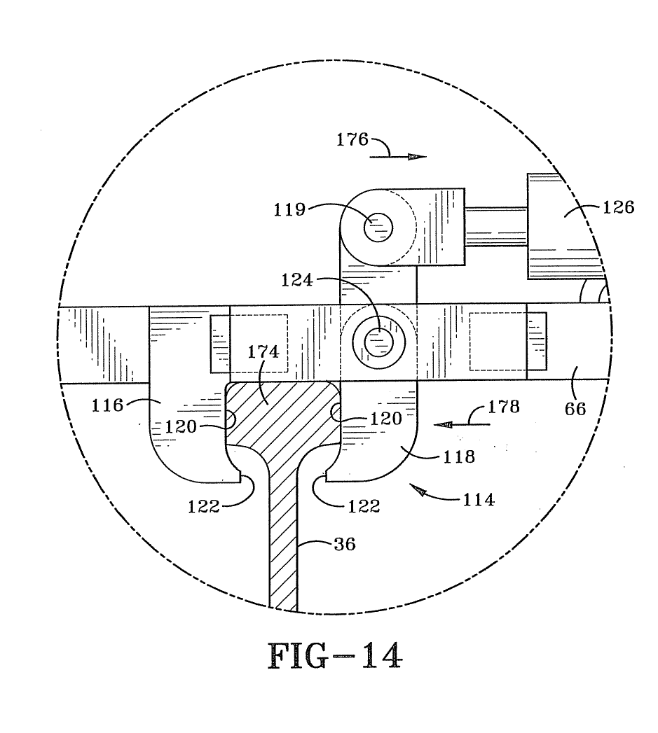

Next, FIG. 12 illustrates rail saw assembly 26 hovering over rails 36 with rail clamping mechanism 114 disengaged. Further, cable clamping joint 144 is seen connected to boom assembly 54 and cable 140 is balancing rail saw assembly 26. FIGS. 13 and 14 illustrate rail saw assembly 26 being moved downward by boom assembly 54 in the direction associated with arrow 172 until saw frame 64 rests on rails 36. In particular, saw frame 64 rests on rail heads 174 of rails 36. Once saw frame 64 is resting on rail heads 174, the operator manipulates control switches 112 to engage clamping mechanism 114. Specifically, when clamping mechanism 114 is engaged, locking cylinder 126 is retracted in the direction associated with arrow 176 and pivots movable jaw 118 in the direction associated with arrow 178. Locking cylinder 126 continues to exert a predetermined force while movable jaw 118 positions rail head 174 between fixed jaw 116 and movable jaw 118, thereby at least partially encircling rail head 174 between fixed jaw 116, movable jaw 118, and the bottom of a portion of saw frame 64. At the opposite end, saw frame 64 merely rests upon rail head 174 and maintains a perpendicular alignment between rails 36. Further, clamping mechanism 114 preferably includes two sets of fixed jaws and movable jaws thereby ensuring that rail saw assembly 26 is perpendicular to the particular rail that is intended to be cut.

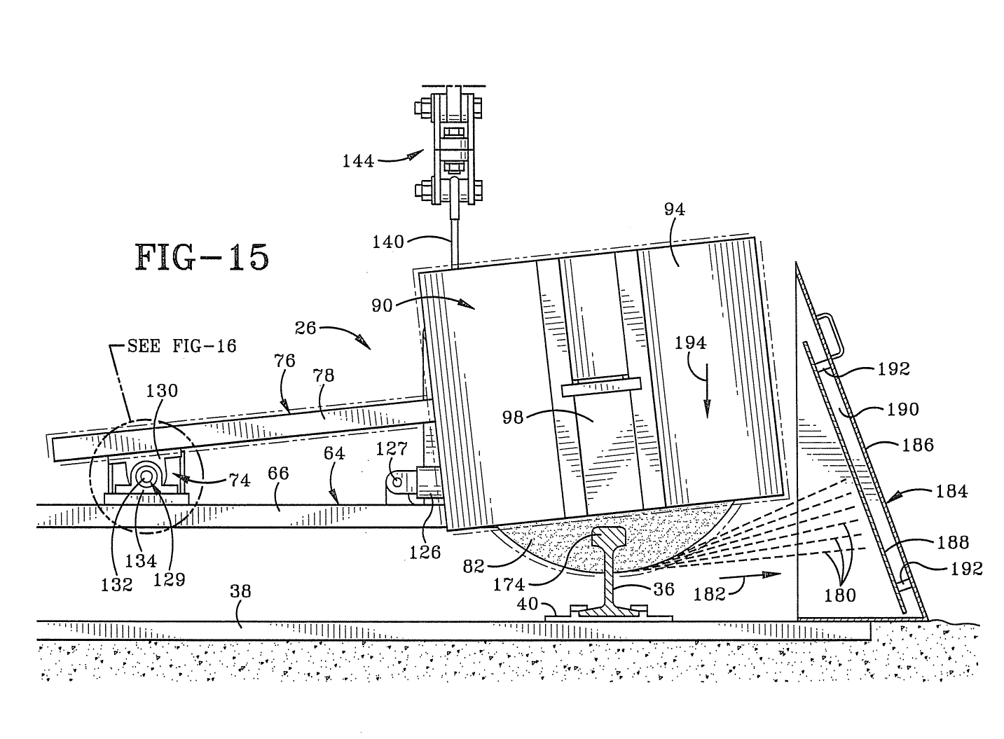

FIGS. 15, 16 and 17 illustrate the operation of blade 82 and eccentric pivot joint 74 with respect to cutting frame 76. After saw frame 64 is located perpendicular to rail heads 174, the operator engages blade 82 as well as eccentric motor 136. Advantageously, blade 82 is rotated in the direction so as to permit sparks 180 to be thrown in the direction associated with arrow 182. Further, a spark guard 184 is located proximate blade 82 and arranged to receive sparks 180 during operation. Spark guard 184 preferably includes an outer shell 186 and an inner shell 188 separated by a cavity 190 formed with spacers 192. In a preferred embodiment, the outer shell is aluminum, while the inner shell is stainless steel or other heavy duty material. Spark guard 184 may also include doors 187 which can be closed after operation to contain the sparks and facilitate clean-up. Advantageously, this arrangement permits heat to escape from cavity 190 to keep the spark guard 184 cool as well as reduce the risk of forest fires from sparks emitted beyond the railroad rail. Referring back to the operation, blade 82 and cutting frame 76 are directed downward by gravity and feed rate control cylinder 108 in the direction associated with arrow 194. While gravity pulls cutting frame 76 and saw blade 82 downward, feed rate control cylinder 108 also acts to resist the downward movement to ensure that saw blade 82 does not stall during operation. While feed rate control cylinder 108 pivots the cutting frame 76 about eccentric pivot joint 74, motor 136 operates to create eccentric movement within eccentric pivot joint 74. As specifically seen in FIG. 16, motor 136 imparts a generally rotational movement that permits the inner portion of the shaft to move eccentrically with respect to the outer portion of the shaft and thereby imparts movement in all directions as seen in FIG. 16. In particular, the eccentric movement imparts movements illustrated in dashed lines in FIG. 16. Eccentric motor 136 imparts reciprocating movement due to the eccentric movement at pivot joint 74. Advantageously, this means that while the feed rate controller ensures that saw blade 82 does not stall, which is operated by blade motor 88, the reciprocating motion assists in material removal during the cutting of rail 36.

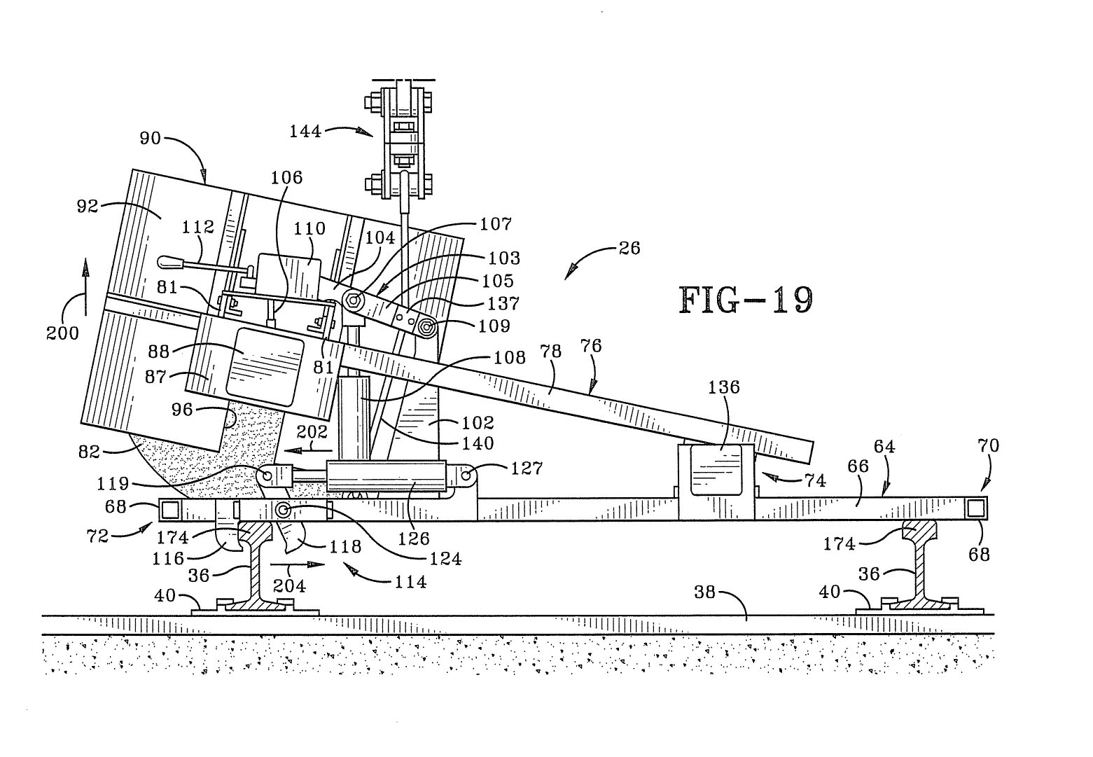

Next, FIG. 18 illustrates blade 82 completely cut through rails 36 in the direction associated with arrow 196, and the resulting movement of rail door 98 in the direction associated with arrow 198 caused by rails 36 during the cutting operation. FIG. 19 then shows saw blade 82 and cutting frame 76 being rotated about eccentric pivot joint 74 to raise saw blade 82 in the direction associated with arrow 200 by feed rate controller 108 to remove saw blade 82 from rails 36. Next, rail clamping mechanism 114 is extended in the direction associated with arrow 202, thereby imparting a rotational movement of movable jaw 118 in the direction associated with arrow 204. Advantageously, pivotal movement of movable jaw 118 disengages the rail clamping mechanism and permits movement of rail saw assembly 26.

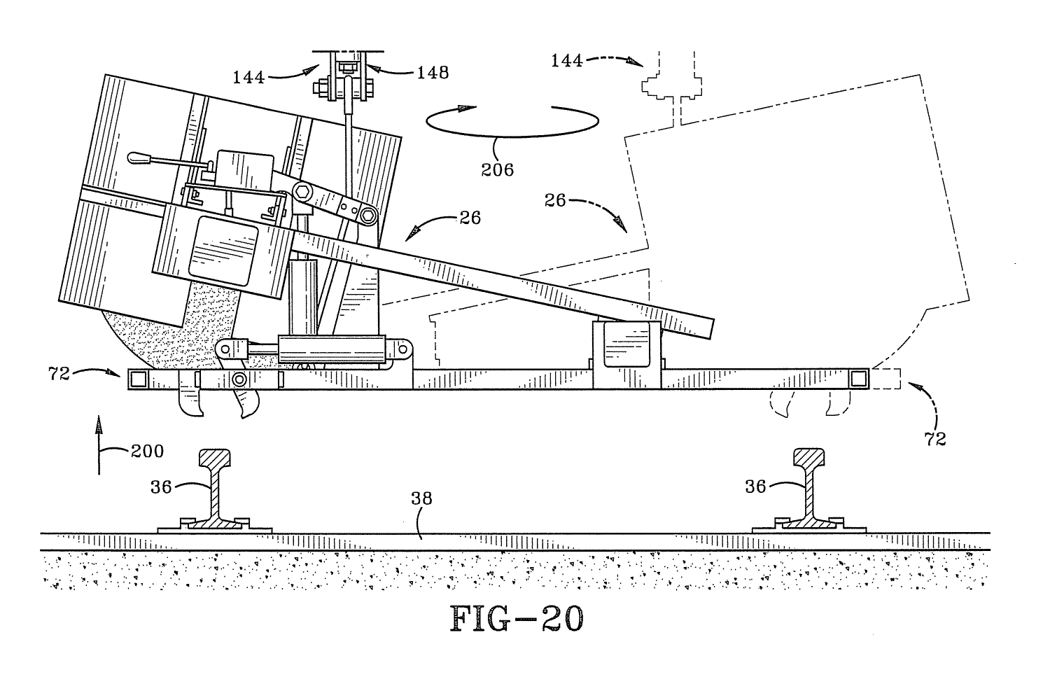

FIG. 20 illustrates rail saw assembly 26 raised further in the direction associated with arrow 200 until the rail clamping mechanism is no longer surrounding rails 36. Next, rail saw assembly 26 is rotated in the direction associated with arrow 206 until the rail clamping mechanism is located directly above rails 36 opposite the first rail which was cut. Accordingly, the same procedure can be followed to lower the saw assembly onto opposing rails 36 to permit a second cutting operation. While the method of operation has been shown and described with only a single rail, it is within the spirit and scope of the present invention to cut the same rail in more than one location, or cut opposing rails at approximately the same locations to remove parallel sections of rails. Further, it is also within the spirit and scope of the present invention as claimed to operate rail saw assembly 26 in the same direction regardless of which rail is being cut. For example, rails 36 may both be cut with the movable jaw being located on the right side of each rail, the left side of each rail, or opposing sides of each rail.

Thus, rail saw assembly 26 provides a mechanism for precision cutting of a railroad rail while maintaining the safety of the operator. The rail saw assembly is easily located perpendicular to the rails that are to be cut, and is securely clamped prior to the cutting operation. Further, the rail saw may impart an eccentric movement at a pivot joint to provide a reciprocating action to assist in the cutting operation, as well as a feed control mechanism to ensure that the blade does not stall during cutting.

It will be evident to one skilled in the art that a variety of changes can be made that are within the spirit and scope of the present invention. For instance, the operator may control the movement of the boom, or the saw assembly operation from a remote location. Further, the hydraulic system may be replaced with an electrical, a pneumatic, or a magnetic style control system. Still further, the rail clamping mechanism may have opposing clamping mechanisms to secure the saw assembly to more than one rail at a time, and may also include adjustable rail clamping mechanisms so that the distance between opposing rail clamping mechanisms can be changed as necessary.

Accordingly, the railroad rail saw is an effective, safe, inexpensive, and efficient device that achieves all of the enumerated objectives of the invention, provides for eliminating difficulties in common art devices, systems and methods, and solves problems and obtains new results in the art.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is by way of example and scope of the invention is not limited to the exact details shown or described.

Having now described the features discoveries, and principles of the invention, the manner in which the railroad rail saw is construed and used, the characteristics of the construction, and the advantageous new and useful results obtained; the new and useful structures, devices, elements, arrangement, parts, and combinations are set forth in the appended claims.

1. A rail saw comprising:
a mounting boom for connection to a railroad machine;
a saw frame secured to the mounting boom;
a saw mounted to the saw frame; and
a saw blade which is maintained perpendicular to a longitudinal axis of a rail during a cutting operation.

2. The rail saw of claim 1 wherein the saw blade is mounted on a cutting frame and the cutting frame is pivotably mounted to the saw frame.

3. The rail saw of claim 2 wherein the cutting frame pivots eccentrically at the saw frame.

4. The rail saw of claim 3 wherein the saw blade reciprocates in directions transverse to the longitudinal axis.

5. The rail saw of claim 2 further comprising a feed rate controller configured to control a pivot rate of the cutting frame.

6. The rail saw of claim 5 wherein the feed rate controller comprises a hydraulic cylinder.

7. The rail saw of claim 1 further comprising a rail clamping mechanism which locates the saw blade perpendicular to the longitudinal axis of the rail.

8. The rail saw of claim 7 wherein the rail clamping mechanism comprises a first and second jaw; and
wherein the rail is secured between the first jaw and the second jaw during the cutting operation.

9. The rail saw of claim 7 wherein the saw frame rests on the rail when the rail clamping mechanism engages the rail.

10. The rail saw of claim 9 wherein the saw frame rests on two rails when the rail clamping mechanism engages one of the two rails.

11. The rail saw of claim 7 wherein the rail clamping mechanism engages the railroad machine to secure the saw frame during transit.

12. The rail saw of claim 1 wherein the saw frame is rotatably secured to the mounting boom.

13. The rail saw of claim 12 wherein the saw blade operates in a first direction and a second direction opposite the first direction; and
wherein both the first and the second directions are transverse to the longitudinal axis of the rail.

14. The rail saw of claim 1 wherein the railroad machine is self-propelled and further comprises a personnel carrier and a hauling platform.

15. The rail saw of claim 1 wherein the cutting operation is controlled from a remote location away from the saw frame and a plurality of cutting sparks are directed away from the saw frame during the cuffing operation.

16. The rail saw of claim 15 further comprising a spark guard for receiving the plurality of cutting sparks, wherein the spark guard comprises an inner body of a first material spaced apart from an outer body of a second material.

17. The rail saw of claim 2 wherein a cutting frame pivots about the saw frame at a location distal the saw blade.

18. A rail saw comprising:
a mounting boom having a pivotable arm and pivotably connected to a railroad machine with at least two pivot axes;
a saw frame rotatably connected to the pivotable arm with at least 180 degrees of rotation;
a cutting frame pivotably connected to the saw frame; and
a saw blade rotatably connected to the cutting frame.

19. A method of cutting a railroad rail comprising the steps of:
locating a railroad machine having a rail saw assembly proximate a rail;
releasing a rail saw assembly rail clamping mechanism which secured a saw frame assembly at a transit position on the railroad machine;
moving the saw frame from the transit position to a cutting position;
engaging the rail clamping mechanism on two sides of the rail;
rotating a saw; and
pivoting the saw with a feed rate controller to cut the rail.

20. The method of claim 19 further comprising the steps of:
pivoting the saw with the feed rate controller in a direction away from the rail;
releasing the rail clamping mechanism from the rail;
moving the saw frame from the cutting position to the transit position; and
engaging the rail clamping mechanism in the transit position.
